(19) United States
(12) Patent Application Publication
(10) Pub. No.: US 2023/0301273 A1
(43) Pub. Date: Sep. 28, 2023

(54) Animal Training Assembly

(71) Applicant: Anthony Alonci, Providence Village, TX (US)

(72) Inventor: Anthony Alonci, Providence Village, TX (US)

(21) Appl. No.: 17/700,597

(22) Filed: Mar. 22, 2022

(51) Int. Cl. A01K 27/00

(52) U.S. Cl. CPC A01K 27/001; A01K 27/009

(57) ABSTRACT

An animal training assembly includes a belt that can be worn around a user's waist and a base unit is provided which is releasably attachable to the belt. The base unit broadcasts a location signal which corresponds to a predetermined distance from the base unit. A collar is provided which can be worn around a neck of an animal. A shock unit is coupled to the collar such that the shock unit is in electrical communication with the animal. The shock unit is in remote communication with the base unit such that the shock unit receives the location signal from the base unit. The shock unit delivers an electrical shock to the animal when the shock unit determines that the shock unit has moved beyond the predetermined distance from the base unit to persuade the animal to move closer to the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to training devices and more particularly pertains to a new training device for leash-less training of a domesticated animal. The device includes a base unit that is wearable on a user and a shock unit that is wearable on an animal's collar. The base unit broadcasts a location signal to the shock unit and the shock unit delivers an electrical shock to the animal when the animal moves beyond a predetermined distance from the base unit. In this way the animal is encouraged to stay near the user. Additionally, the base unit emits an audible alert when the shock unit shocks the animal to alert the user that the animal has received a shock.

### (2) Description of Related Art Including Information Disclosed Under 37 CFR 1.97 and 1.98

The prior art relates to training devices including a tracking device for wirelessly tracking the location of a pet. The prior art discloses a method of wirelessly updating firmware on an animal tracking device. The prior art discloses a wireless alarm for emitting an audible alert when a pet has been left unattended in a vehicle. The prior art discloses a virtual boundary system which employs data from a global positioning system to indentify the location of an object with respect to a specified boundary. The prior art discloses a wireless lost object location device which emits an alert when an object moves beyond a pre-determined distance from a user. The prior art discloses a pet correction device that includes a stimulation unit that is integrated into a dog collar and a personal electronic device that is in wireless communication with the stimulation unit. The prior art discloses an animal aversion device that includes a pair of shock units that are each wearable on a respective pair of dogs and which shock the dogs when the dogs come too close to each other.

### BRIEF SUMMARY OF THE INVENTION

An embodiment of the disclosure meets the needs presented above by generally comprising a belt that can be worn around a user's waist and a base unit is provided which is releasably attachable to the belt. The base unit broadcasts a location signal which corresponds to a predetermined distance from the base unit. A collar is provided which can be worn around a neck of an animal. A shock unit is coupled to the collar such that the shock unit is in electrical communication with the animal. The shock unit is in remote communication with the base unit such that the shock unit receives the location signal from the base unit. The shock unit delivers an electrical shock to the animal when the shock unit determines that the shock unit has moved beyond the predetermined distance from the base unit to persuade the animal to move closer to the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an animal training assembly according to an embodiment of the disclosure.

FIG. 2 is a right side view of a base unit of an embodiment of the disclosure.

FIG. 3 is a front view of a base unit of an embodiment of the disclosure.

FIG. 4 is a top view of a shock unit of an embodiment of the disclosure.

FIG. 5 is a front view of a shock unit of an embodiment of the disclosure.

FIG. 6 is a perspective in-use view of an embodiment of the disclosure.

FIG. 7 is a schematic view of an embodiment of the disclosure.

### DETAILED DESCRIPTION OF THE INVENTION

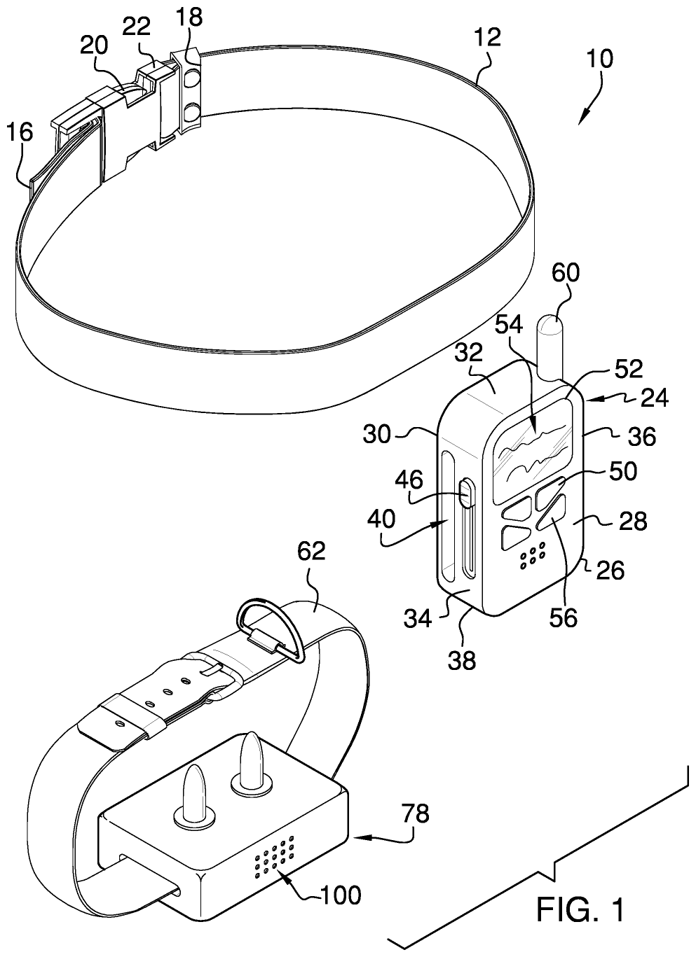

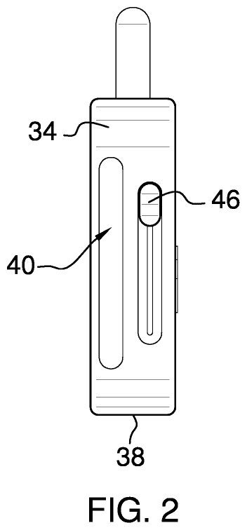

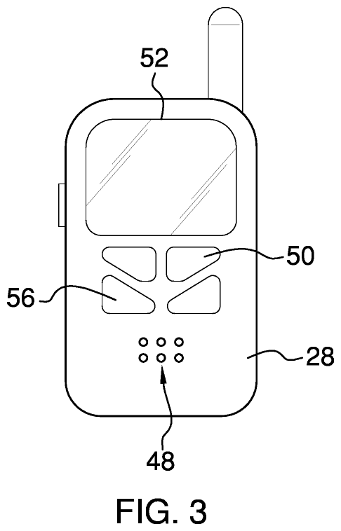

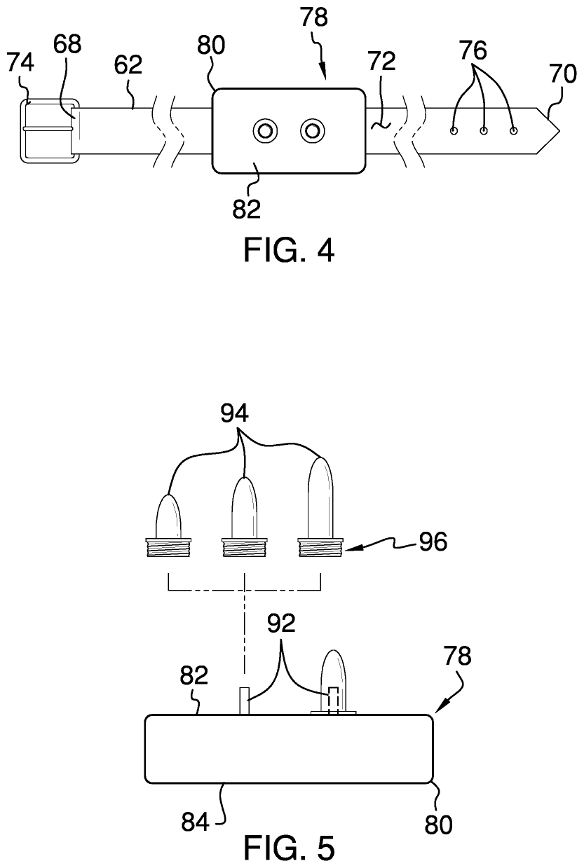

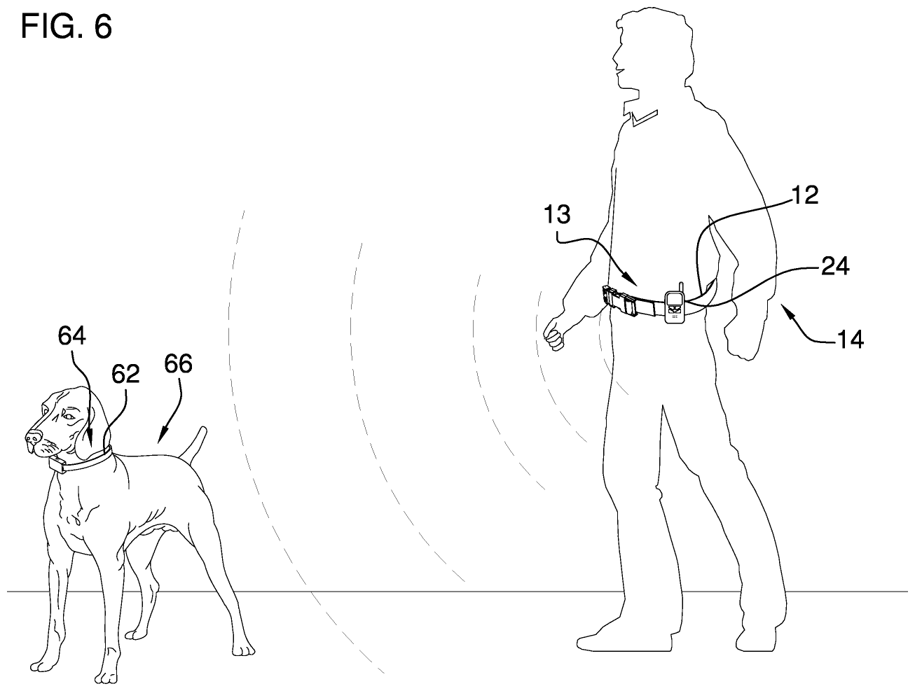

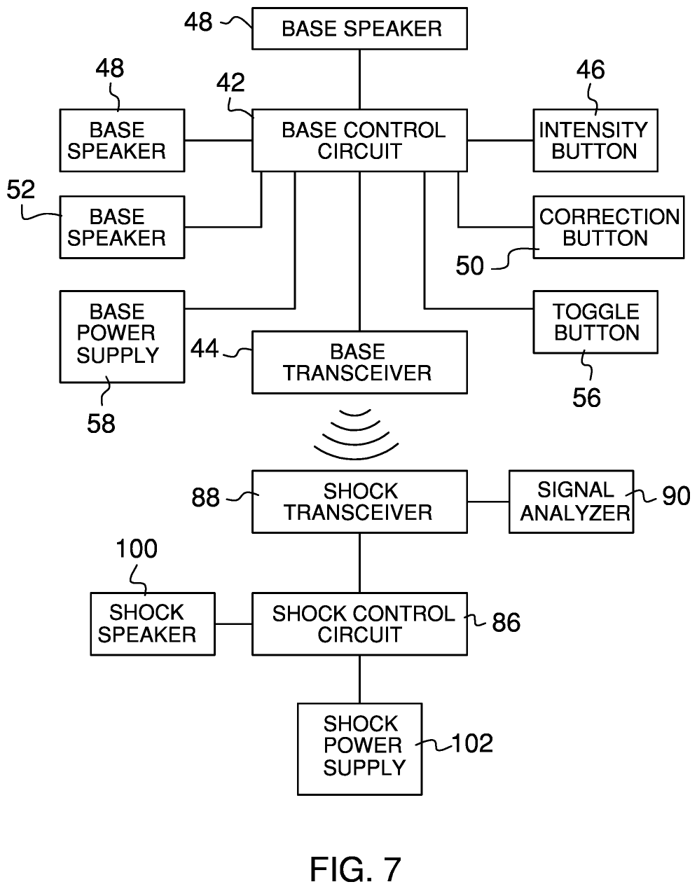

With reference now to the drawings, and in particular to FIGS. 1 through 7 thereof, a new training device embodying the principles and concepts of an embodiment of the disclosure and generally designated by the reference numeral 10 will be described.

As best illustrated in FIGS. 1 through 7, the animal training assembly 10 generally comprises a belt 12 for wearing around a waist 13 of a user 14, and the belt 12 has a primary end 16 and a secondary end 18. The user 14 may be an individual that is training a domesticated animal such as a dog that is being trained for leash-less walking. A first mating unit 20 is coupled to the primary end 16 of the belt 12 and a second mating unit 22 is slidably coupled to the secondary end 18 of the belt 12. The first mating unit 20 releasably engages the second mating unit 22 for retaining the belt 12 around the user's waist 13. Furthermore, the belt 12 is adjustable in the second mating unit 22 for adjusting a diameter of a closed loop formed by the belt 12 when the first mating unit 20 is releasably engaged to the second mating unit 22.

A base unit 24 is provided that is releasably attachable to the belt 12 such that the base unit 24 is accessible to the user 14. The base unit 24 broadcasts a location signal and the location signal has an adjustable intensity. In this way the location signal can be adjusted to correspond to a predetermined distance from the base unit 24. The predetermined distance may range between approximately 3.0 feet to 12.0 feet. The base unit 24 comprises a base housing 26 that has a front wall 28, a back wall 30 and an outer wall 32 extending between the front wall 28 and the back wall 30, and the outer wall 32 has a first lateral side 34, a second lateral side 36 and a bottom side 38. The outer wall 32 has a slot 40 extending through the first lateral side 34 and the second lateral side 36, and the belt 12 is extendable through the slot 40 for mounting the base housing 26 to the belt 12.

The base unit 24 includes a base control circuit 42 is integrated into the base housing 26 and the base control circuit 42 receives a correction input. A base transceiver 44 is integrated into the base housing 26 and the base transceiver 44 is electrically coupled to the base control circuit 42. The base transceiver 44 broadcasts the location signal and the base transceiver 44 is actuatable to broadcast a correction signal. The base transceiver 44 may comprise a radio frequency transceiver or the like with an operational range of at least 100.0 feet.

The base unit 24 includes an intensity button 46 is slidably integrated into the base housing 26 and the intensity button 46 is electrically coupled to the base control circuit 42. The intensity button 46 adjusts an intensity of the location signal between a minimum intensity and a maximum intensity. The base unit 24 includes a base speaker 48 that is integrated into the base housing 26 to emit an audible alert. The base speaker 48 is electrically coupled to the base control circuit 42 and the base speaker 48 is turned on when the base control circuit 42 receives the correction input.

The base unit 24 includes a correction button 50 that is movably integrated into the front wall 28 of the base housing 26. The correction button 50 is electrically coupled to the base control circuit 42 and the base transceiver 44 broadcasts the correction signal when the correction button 50 is depressed. The base unit 24 includes a display 52 that is coupled to the front wall 28 of the base housing 26 such that the display 52 is visible to the user 14. The display 52 is electrically coupled to the base control circuit 42 and the display 52 displays indicia 54 comprising words and numbers for communication various operational parameters of the base unit 24. The display 52 may comprise a liquid crystal display or other type of electronic display.

The base unit 24 includes a toggle button 56 that is movably integrated into the front wall 28 of the base housing 26. The toggle button 56 is electrically coupled to the base control circuit 42 and the display 52 is actuated to display 52 varying menus when the toggle button 56 is depressed. The base unit 24 includes a base power supply 58 that is integrated into the base housing 26. The base power supply 58 is electrically coupled to the base control circuit 42 and the base power supply 58 comprises at least one battery. The base unit 24 may include an antenna 60 that is coupled to and extends upwardly from the base housing 26 and the antenna 60 may be electrically coupled to the base transceiver 44 for enhancing the operational range of the base transceiver 44.

A collar 62 is provided that can be worn around a neck 64 of an animal 66. The collar 62 has a first end 68, a second end 70 and a back surface 72 extending between the first end 68 and the second end 70, and a coupler 74 is movably disposed on the first end 68. The coupler 74 releasably engages a respective one of a plurality of engagement points 76 that is each integrated into the collar 62 such that the collar 62 forms a closed loop. The coupler 74 may comprise a belt buckle or other similar type of releasable, mechanical coupler and each of the plurality of engagement points 76 may comprise a series of holes extending through the collar 62.

A shock unit 78 is coupled to the collar 62 such that the shock unit 78 is in electrical communication with the animal 66. The shock unit 78 is in remote communication with the base unit 24 such that the shock unit 78 receives the location signal from the base unit 24. Furthermore, the shock unit 78 delivers an electrical shock to the animal 66 when the shock unit 78 determines that the shock unit 78 has moved beyond the predetermined distance from the base unit 24. In this way the shock unit 78 can persuade the animal 66 to move closer to the user 14.

The shock unit 78 comprises a shock housing 80 that has a front wall 82 and a back wall 84, and the back wall 84 is attached to the back surface 72 of the collar 62. The shock unit 78 includes a shock control circuit 86 that is integrated into the shock housing 80, and the shock control circuit 86 receives a shock input and a de-actuate input. The shock unit 78 includes a shock transceiver 88 that is integrated into the shock housing 80 and the shock transceiver 88 is electrically coupled to the shock control circuit 86. The shock transceiver 88 is in wireless communication with the base transceiver 44 and the shock transceiver 88 receives the location signal and the correction signal from the base transceiver 44. The shock transceiver 88 may comprise a radio frequency transceiver or the like which has an operational range of at least 100.0 feet.

The shock transceiver 88 broadcasts an alert signal to the base transceiver 44 when the shock control circuit 86 receives the shock input. Additionally, the base control circuit 42 receives the correction input when the base transceiver 44 receives the alert signal. The shock unit 78 includes a signal analyzer 90 that is integrated into the shock housing 80. The signal analyzer 90 is electrically coupled to the shock control circuit 86 and the signal analyzer 90 analyzes the location signal received from the base transceiver 44. The shock control circuit 86 receives the shock input when the signal analyzer 90 determines that the signal strength of the location signal has fallen below a pre-determined trigger threshold or when the shock transceiver 88 receives the correction signal. Furthermore, the shock control circuit 86 receives the de-actuate input when the signal analyzer 90 determines that the signal strength of the location signal has fallen below a pre-determined minimum signal strength. In this way the shock control circuit 86 will not receive the shock input when the user 14 and the animal 66 are accidentally separated for a long period of time.

A pair of electrodes 92 is each coupled to and extends away from the front wall 28 of the shock housing 80. Each of the electrodes 92 is comprised of an electrically conductive material such that each of the electrodes 92 is in electrical communication with the animal 66 when the collar 62 is worn around the animal's neck 64. Each of the electrodes 92 is electrically coupled to the shock control circuit 86 and the shock control circuit 86 discharges an electrical charge into each of the electrodes 92 after a pre-determined duration of time passes when the shock control circuit 86 receives the shock input. Subsequently each of the electrodes 92 can deliver the electrical charge into the animal 66.

A plurality of cones 94 is each of the cones 94 is releasably attachable to a respective one of the electrodes 92. Each of the cones 94 is comprised of an electrically conductive material and each of the cones 94 has a unique length with respect to each other. Each of the cones 94 facilitates the electrodes 92 to be in electrical communication with animals of varying sizes. Each of the cones 94 may have a threaded portion 96 on an outer surface 98 of the cones 94 which threadably engages the shock housing 80.

A shock speaker 100 is integrated into the shock housing 80 such that the shock speaker 100 emits audible sounds outwardly from the shock housing 80. The shock speaker 100 is electrically coupled to the shock control circuit 86 and the shock speaker 100 is actuated when the shock control circuit 86 receives the shock input. In this way the shock speaker 100 audibly alerts the animal 66 of the impending shock that will be delivered by the electrodes 92. Thus, the animal 66 is given the opportunity to correct its behavior prior to receiving the electrical shock. The pre-determined duration of time may be approximately 5.0 seconds. A shock power supply 102 is integrated into the shock housing 80, the shock power supply 102 is electrically coupled to the shock control circuit 86 and the shock power supply 102 comprises at least one battery.

In use, the toggle button 56 on the base unit 24 is depressed a pre-determined number of times to set the intensity of the shock unit 78 between a minimum intensity and a maximum intensity, depending on the size of the animal 66 being trained. Additionally, the intensity button 46 is manipulated to establish the distance that the animal 66 can move away from the user 14 without receiving a shock from the shock unit 78. The shock unit 78 delivers the shock to the animal 66 when the animal 66 moves beyond the distance from the user 14 established with the intensity button 46. Additionally, the base speaker 48 emits an audible alert to notify the user 14 that the animal 66 has received the shock. In this way the animal 66 is encouraged to move closer to the user 14 thereby training the animal 66 to remain near the user 14 while the animal 66 is being walked outdoors. Additionally, the shock unit 78 is disabled in the event that the animal 66 moves beyond a predetermined maximum distance. In this way the animal 66 does not continually receive the shock when the user 14 and the animal 66 are accidentally separated for an extended period of time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal training assembly for training behavior in an animal with a mild electric shock, said assembly comprising:
a belt being configured to be worn around a user's waist;
a base unit being releasably attachable to said belt wherein said base unit is configured to be accessible to the user, said base unit broadcasting a location signal, said location signal having an adjustable intensity thereby facilitating said location signal to correspond to a predetermined distance from said base unit;
a collar being configured to be worn around a neck of an animal; and
a shock unit being coupled to said collar wherein said shock unit is configured to be in electrical communication with the animal, said shock unit being in remote communication with said base unit such that said shock unit receives said location signal from said base unit, said shock unit delivering an electrical shock to the animal when said shock unit determines that said shock unit has moved beyond the predetermined distance from said base unit wherein said shock unit is configured to persuade the animal to move closer to the user.

2. The assembly according to claim 1, wherein:
said belt has a primary end and a secondary end;
said assembly includes a first mating unit being coupled to said primary end of said belt;
said assembly includes a second mating unit being slidably coupled to said secondary end of said belt, said primary mating unit releasably engaging said secondary mating unit for retaining said belt around the user's waist, said belt being adjustable in said second mating unit for adjusting a diameter of a closed loop formed by said belt when said first mating unit is releasably engaged to said second mating unit; and
said base unit comprises a base housing having a front wall, a back wall and an outer wall extending between said front wall and said back wall, said outer wall having a first lateral side, a second lateral side and a bottom side, said outer wall having a slot extending through said first lateral side and said second lateral side, said belt being extendable through said slot for mounting said base housing to said belt.

3. The assembly according to claim 2, wherein said base unit comprises:
a base control circuit being integrated into said base housing, said base control circuit receiving a correction input;
a base transceiver being integrated into said base housing, said base transceiver being electrically coupled to said base control circuit, said base transceiver broadcasting said location signal, said base transceiver being actuatable to broadcast a correction signal; and
an intensity button being slidably integrated into said base housing wherein said intensity button is configured to be manipulated, said intensity button being electrically coupled to said base control circuit, said intensity button adjusting an intensity of said location signal between a minimum intensity and a maximum intensity.

4. The assembly according to claim 3, wherein said base unit comprises:
a base speaker being integrated into said base housing wherein said base speaker is configured to emit an audible alert, said base speaker being electrically coupled to said base control circuit, said base speaker being turned on when said base control circuit receives said correction input; and
a correction button being movably integrated into said front wall of said base housing, said correction button being electrically coupled to said base control circuit, said base transceiver broadcasting said correction signal when said correction button is depressed.

5. The assembly according to claim 4, wherein said base unit comprises:
a display being coupled to said front wall of said base housing wherein said display is configured to be visible to the user, said display being electrically coupled to said control circuit, said display displaying indicia comprising words and numbers for communication various operational parameters of said base unit; and
a toggle button being movably integrated into said front wall of said base housing, said toggle button being electrically coupled to said base control circuit, said display being actuated to display varying menus when said toggle button is depressed.

6. The assembly according to claim 1, wherein:
said collar has a first end, a second end and a back surface extending between said first end and said second end, said collar having a coupler being movably disposed on said first end, said coupler releasably engaging a respective one of a plurality of engagement points each being integrated into said collar such that said collar forms a closed loop; and
said shock unit comprises:
a shock housing having a front wall and a back wall, said back wall being attached to said back surface of said collar; and
a shock control circuit being integrated into said shock housing, said shock control circuit receiving a shock input, said shock control circuit receiving a de-actuate input.

7. The assembly according to claim 6, wherein:
said base unit includes a base transceiver and a base control circuit, said base transceiver broadcasting a location signal;
said shock unit includes a shock transceiver being integrated into said shock housing, said shock transceiver being electrically coupled to said shock control circuit, said shock transceiver being in wireless communication with said base transceiver, said shock transceiver receiving said location signal from said base transceiver, said shock transceiver broadcasting an alert signal to said base transceiver when said shock control circuit receives said shock input, said base control circuit receiving a correction input when said base transceiver receives said alert signal.

8. The assembly according to claim 7, wherein said shock unit includes a signal analyzer being integrated into said shock housing, said signal analyzer being electrically coupled to said shock control circuit, said signal analyzer analyzing said location signal received from said base transceiver, said shock control circuit receiving a shock input when said signal analyzer determines that a signal strength of said location signal has fallen below a pre-determined trigger threshold.

9. The assembly according to claim 6, wherein said shock control circuit receives a de-actuate input when said signal analyzer determines that said signal strength of said location signal has fallen below a pre-determined minimum signal strength.

10. The assembly according to claim 6, wherein said shock control unit includes a pair of electrodes, each of said electrodes being coupled to and extending away from said front wall of said shock housing, each of said electrodes being comprised of an electrically conductive material wherein each of said electrodes is configured to be in electrical communication with the animal's skin when said collar is worn around the animal's neck, each of said electrodes being electrically coupled to said control circuit, said control circuit discharging an electrical charge into each of said electrodes when a pre-determined duration of time passes after said control circuit receives said shock input wherein each of said electrodes is configured to deliver the electrical charge into the animal's skin after said pre-determined duration of time passes.

11. The assembly according to claim 10, further comprising a plurality of cones, each of said cones being releasably attachable to a respective one of said electrodes, each of said cones being comprised of an electrically conductive material, each of said cones having a unique length with respect to each other wherein each of said cones is configured to facilitate said electrodes to be in electrical communication with animals of varying sizes.

12. The assembly according to claim 6, further comprising a shock speaker being integrated into said shock housing wherein said shock speaker is configured to emit audible sounds outwardly from said shock housing, said shock speaker being electrically coupled to said shock control circuit, said shock speaker being actuated when said shock control circuit receives said shock input.

13. An animal training assembly for training behavior in an animal with a mild electric shock, said assembly comprising:
a belt being configured to be worn around a user's waist, said belt having a primary end and a secondary end;
a first mating unit being coupled to said primary end of said belt;
a second mating unit being slidably coupled to said secondary end of said belt, said primary mating unit releasably engaging said secondary mating unit for retaining said belt around the user's waist, said belt being adjustable in said second mating unit for adjusting a diameter of a closed loop formed by said belt when said first mating unit is releasably engaged to said second mating unit;
a base unit being releasably attachable to said belt wherein said base unit is configured to be accessible to the user, said base unit broadcasting a location signal, said location signal having an adjustable intensity thereby facilitating said location signal to correspond to a predetermined distance from said base unit, said base unit comprising:
a base housing having a front wall, a back wall and an outer wall extending between said front wall and said back wall, said outer wall having a first lateral side, a second lateral side and a bottom side, said outer wall having a slot extending through said first lateral side and said second lateral side, said belt being extendable through said slot for mounting said base housing to said belt;
a base control circuit being integrated into said base housing, said base control circuit receiving a correction input;
a base transceiver being integrated into said base housing, said base transceiver being electrically coupled to said base control circuit, said base transceiver broadcasting said location signal, said base transceiver being actuatable to broadcast a correction signal;
an intensity button being slidably integrated into said base housing wherein said intensity button is configured to be manipulated, said intensity button being electrically coupled to said base control circuit, said intensity button adjusting an intensity of said location signal between a minimum intensity and a maximum intensity;
a base speaker being integrated into said base housing wherein said base speaker is configured to emit an audible alert, said base speaker being electrically coupled to said base control circuit, said base speaker being turned on when said base control circuit receives said correction input;
a correction button being movably integrated into said front wall of said base housing, said correction button being electrically coupled to said base control circuit, said base transceiver broadcasting said correction signal when said correction button is depressed;
a display being coupled to said front wall of said base housing wherein said display is configured to be visible to the user, said display being electrically coupled to said control circuit, said display displaying indicia comprising words and numbers for communication various operational parameters of said base unit;
a toggle button being movably integrated into said front wall of said base housing, said toggle button being electrically coupled to said base control circuit, said display being actuated to display varying menus when said toggle button is depressed; and
a base power supply being integrated into said base housing, said base power supply being electrically coupled to said base control circuit, said base power supply comprising at least one battery;
a collar being configured to be worn around a neck of an animal, said collar having a first end, a second end and a back surface extending between said first end and said second end, said collar having a coupler being movably disposed on said first end, said coupler releasably engaging a respective one of a plurality of engagement points each being integrated into said collar such that said collar forms a closed loop;
a shock unit being coupled to said collar wherein said shock unit is configured to be in electrical communication with the animal, said shock unit being in remote communication with said base unit such that said shock unit receives said location signal from said base unit, said shock unit delivering an electrical shock to the animal when said shock unit determines that said shock unit has moved beyond the predetermined distance from said base unit wherein said shock unit is configured to persuade the animal to move closer to the user, said shock unit comprising:
a shock housing having a front wall and a back wall, said back wall being attached to said back surface of said collar;
a shock control circuit being integrated into said shock housing, said shock control circuit receiving a shock input, said shock control circuit receiving a de-actuate input;
a shock transceiver being integrated into said shock housing, said shock transceiver being electrically coupled to said shock control circuit, said shock transceiver being in wireless communication with said base transceiver, said shock transceiver receiving said location signal from said base transceiver, said shock transceiver broadcasting an alert signal to said base transceiver when said shock control circuit receives said shock input, said base control circuit receiving said correction input when said base transceiver receives said alert signal;
a signal analyzer being integrated into said shock housing, said signal analyzer being electrically coupled to said shock control circuit, said signal analyzer analyzing said location signal received from said base transceiver, said shock control circuit receiving said shock input when said signal analyzer determines that a signal strength of said location signal has fallen below a pre-determined trigger threshold, said shock control circuit receiving said de-actuate input when said signal analyzer determines that said signal strength of said location signal has fallen below a pre-determined minimum signal strength;
a pair of electrodes, each of said electrodes being coupled to and extending away from said front wall of said shock housing, each of said electrodes being comprised of an electrically conductive material wherein each of said electrodes is configured to be in electrical communication with the animal's skin when said collar is worn around the animal's neck, each of said electrodes being electrically coupled to said shock control circuit, said control circuit discharging an electrical charge into each of said electrodes when a pre-determined duration of time passes after said control circuit receives said shock input wherein each of said electrodes is configured to deliver the electrical charge into the animal's skin after said pre-determined duration of time passes;
a plurality of cones, each of said cones being releasably attachable to a respective one of said electrodes, each of said cones being comprised of an electrically conductive material, each of said cones having a unique length with respect to each other wherein each of said cones is configured to facilitate said electrodes to be in electrical communication with animals of varying sizes;
a shock speaker being integrated into said shock housing wherein said shock speaker is configured to emit audible sounds outwardly from said shock housing, said shock speaker being electrically coupled to said shock control circuit, said shock speaker being actuated when said shock control circuit receives said shock input wherein said shock speaker is configured to audibly alert the animal of the impending electrical shock delivered by said electrodes; and
a shock power supply being integrated into said shock housing, said shock power supply being electrically coupled to said shock control circuit, said shock power supply comprising at least one battery.
